(19) United States
(12) Patent Application Publication
(10) Pub. No.: US 2022/0090593 A1
(43) Pub. Date: Mar. 24, 2022

(54) System And Method For a Pump Controller

(71) Applicant: 2291447 Ontario Inc., London (CA)

(72) Inventor: Stuart Bevan, london (CA)

(73) Assignee: 2291447 Ontario Inc., London, ON (CA)

(21) Appl. No.: 17/421,740

(22) PCT Filed: Jan. 9, 2020
(86) PCT No.: PCT/CA2020/050025

§ 371 Date: Jul. 9, 2021

Related U.S. Application Data
(60) Provisional application No. 62/790,987, filed on Jan. 10, 2019.

(51) Int. Cl. F04B 49/06; G05B 13/02; E21B 47/008

(52) U.S. Cl. CPC F04B 49/065; E21B 47/008; G05B 13/0265

(57) ABSTRACT

A method for characterizing a well for control of a pump, comprising inputting well parameters, into a processor and generating from the input well parameters a well profile, the well profile having a plurality of statistically derived values, each said statistical value corresponding to respective operating points of the pump operational data, and each of the plurality of statistical values being derived from respective statistical analyses taken at the respective operating points, each of the plurality of statistical values being based on a respective analysis of a plurality of sampled well head data at a common point of the operating points.

### FIELD

The present matter relates to a method and system for optimizing production in multiphase wells, and more particularly to characterizing wells for optimizing pump control applied to individual, or groups of wells.

### BACKGROUND

Extraction rate of fluids and gas (multiphasic fluids) from reservoirs in geological formations, may be unpredictably variable. This is due, in parts, to the nature of the formations, and the nature of the produced multiphase fluids. An example of multiphasic fluid is a petroleum type fluid, which is a combination of one or more of crude oil, gas, water and other materials. The variability in extraction rate may increase as wells age, partly because of decreases in natural fluid pressure within the geological formations.

Extraction rate may also be dependent on, extraction or lift mechanisms, such as rotary pumps, linear pumps, progressive cavity pumps, plunger type pumps and gas lift mechanisms to name a few-collectively referred to herein as pumps. Pumps provide a constraint on production, as the amount produced is a direct function of the pump rate capacity of a pump. If the rate capacity of a pump exceeds the rate capacity of the well, the pump is then operating below maximum efficiency. As the cost of operating the pump is relatively high, this reduced efficiency translates into a wasted energy cost, and environmental cost. Furthermore, severe pump degradation may be caused by having a pump operate above the well production rate. Conversely, if the pump rate falls below the wells production rate, oil accumulates in the well bore resulting in a disequilibrium between oil flowing into the wellbore and that produced at the wellhead with a resultant drop in production. Furthermore, for some types of pumps it is necessary to always maintain fluid in the wellbore. Thus, control of the pump rate is relatively more critical in this case.

Determining an operating point of the pump may be challenging given many variables. Pumps are primarily controlled by a speed signal. Determining whether to increase the speed, maintain the speed or decrease the speed of the pump is based on a knowledge of the well. Simply modelling the formation from geological data to predict flow and thus anticipate a pump speed (sometimes called a set point) to achieve a level of flow as predicted by the model may not in practice e provide an optimal flow from the well. While formation modelling attempts to simplify complex interactions in a formation it may be unable to accurately predict level of flow when the formations contain complex multi-phase fluids. Another solution is to determine whether the flow is increasing or decreasing and then correspondingly increase or decrease pump speed by preset amounts until the flow stabilizes. However, this approach does not always find the optimal production, nor does it provide for optimal operation of the pump. As may be further appreciated, in a field of multiple wells, control of the pump becomes even more challenging due tot potential and unpredictable influence of neighboring wells in the field.

### SUMMARY

In accordance with an embodiment of the present matter there is provided a system and method to optimize the production of fluid from wells.

In accordance with a further embodiment of the present matter there is provided a method for a well, the method comprising: inputting to a processor well parameters, the well parameters including pump operational data, and well data, the pump operational data including at least one operating point of a pump; obtaining, at respective ones of the operating points of the pump, a plurality of samples of the well data; deriving a representation of variation in a set of the samples at a selected one of the operating points of the pump; and generating a well profile, the well profile representing a relationship between the selected operating points of the pump and the variance representations at those operating points.

In accordance with a further embodiment the method includes applying the generated well profile to a pump controller for the control of the operating point of the pump.

In accordance with a further embodiment, the representation of variation is a variance.

In accordance with a further embodiment the well profile includes standard deviations based on the variance.

In accordance with a further embodiment the well profile includes standard deviations and means, both based on the variance.

In accordance with a further embodiment of the present matter the well data includes at least fluid production information.

In accordance with a further embodiment the well parameters further include manufacturer pump parameters.

In accordance with a further aspect the method includes updating the well profile with ongoing samples of the well data and updating a pump control algorithm with the updated well profile.

In accordance with a further aspect the method provides for the variations in sampled data to be derived by statistical inference by using one or more of a Frequentist inference, and Bayesian inference.

In accordance with a still further aspect the method includes generating well profiles for respective ones of a plurality of wells.

### BRIEF DESCRIPTION OF THE DRAWINGS

The present matter will become more fully understood from the detailed description and the accompanying drawings, wherein

FIG. 1 shows a typical production life cycle of a reservoir in a geological formation;

FIG. 2 shows a typical production decline curve or graph of a typical reservoir;

FIG. 3 shows a schematic diagram of a single well fluid production system;

FIGS. 4a and 4b show graphic representations of a well profile, according to an embodiment of the present matter;

FIG. 5 shows a flow chart for acquiring a dataset of flow/speed datapoints according to an embodiment of the present matter;

FIG. 6 shows a flow chart of a method for quantifying variation in the acquired flow dataset to generate the well profile according to an embodiment of the present matter;

FIG. 7 shows a schematic flow diagram for implementing a method to optimize fluid production by a pump in a well using a well profile according to an embodiment of the present matter;

FIG. 8 shows a generalized flowchart for controlling a pump using a generated well profile according to an embodiment of the present matter;

FIG. 9 shows a schematic block diagram of a multi-well system using well profiles generated according to an embodiment of the present matter;

FIG. 10 shows a schematic flow diagram for implementing a process in multiple wells to optimize the fluid production system according to an embodiment of the present matter; and

FIG. 11 shows a schematic flow diagram for implementing a process in multiple wells to optimize the fluid production system according to another embodiment of the present matter.

### DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for purposes of providing a thorough understanding of the exemplary designs of the present disclosure. It will be apparent to those skilled in the art that the exemplary designs described herein may be practiced without these specific details. In some instances, well-known structures and devices are shown in block diagram form to avoid obscuring the novelty of the exemplary designs presented herein.

Referring to FIG. 1 there is shown a diagram of a typical production life cycle 100 of a reservoir in a geological formation. In the example diagram an oil production rate is shown along a vertical axis 102 and time (years) is shown on a horizontal axis 104. Different stages are followed over time which include well discovery, well appraisal, reservoir development or production build-up, production plateau, eventual production decline, and abandonment of the reservoirs. Important decisions must be made at each of these stages in order to properly allocate resources and to assure that the reservoir meets its production potential. As development of the reservoir continues, diverse types of reservoir data continue to be collected, such as seismic, well log data, and production data. That reservoir data may be combined to construct an evolving understanding of the distribution of reservoir properties in a formation. Other data may also be collected, such as historical data, user inputs, economic information, other measurement data and other parameters of interest. Understanding this data aids in making proper production management decisions.

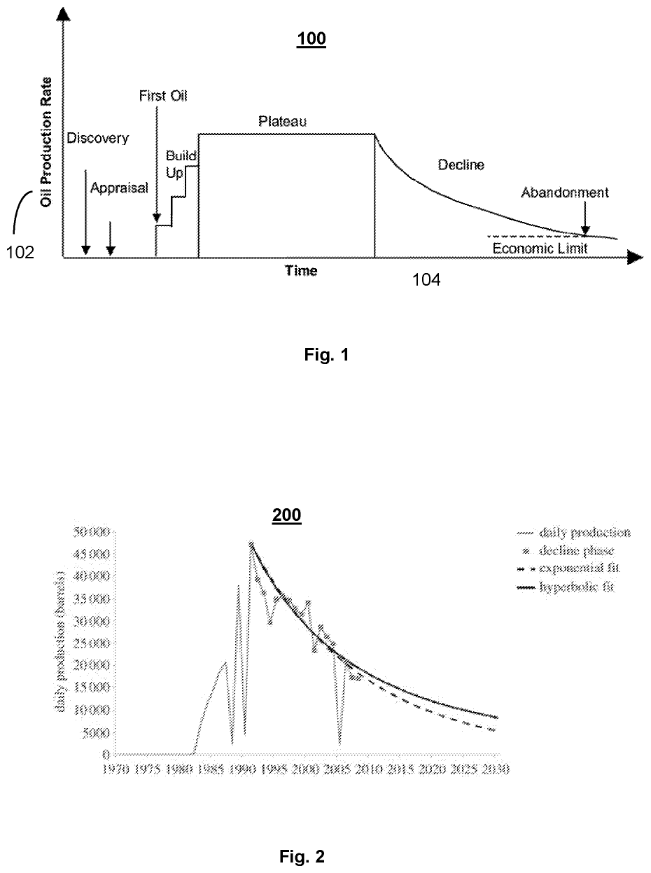

Referring to FIG. 2 there is shown a typical production decline curve 200 of a typical reservoir. A production decline curve 200 is a curve fitted to data of fluid production over time. As will be appreciated, optimization of production is a key to economic viability of a reservoir. As may be further appreciated the actual production decline curve for wells is not known in advance but is created retrospectively over the lifetime of the well's production. Decline curves may however be extrapolated into the future based on historical data for that well. Production decline curves may illustrate a high initial production rate and a steep initial decline characteristic as for example found with shale wells, or a slower decline as found with many conventional gas wells. Conventional reservoirs tend to follow an exponential decline curve, but the performance of unconventional low permeability reservoirs is better modeled using hyperbolic decline trends. For example, as shown in FIG. 1, a length of time of a plateau region or a commencement time, slope, and duration of the decline region may all be extrapolated from previous and currently measured data but is seldom known in advance.

While the decline curve model may be used to predict flow trends for the reservoir over the lifespan of the well, actual production flow on a day to day basis may exhibit dramatic fluctuations about the decline curve. The lift mechanisms may have to contend with this natural variability in fluid production and have one or more of their operating parameters adjusted in order to change an operating point of the lift mechanism. Depending on the type of lift mechanism this may be speed or pressure (referred collectively herein as “speed”). Many decisions regarding, for example, equipment sizing and pumping rates etc. that are made at the beginning of the life cycle of a well, may rarely hold constant throughout the life of the well. As may be seen from the decline curve, production rate of the well may drop significantly (almost asymptotically) with the progress of time. This may lead to a problem with pumps being operated at a much higher speed than the flow rate deliverable from the well—called over pumping. Over pumping may cause accelerated wear and tear on equipment leading to increased failure rates and consequently, higher costs and environmental pollution. In addition, normal wear and tear of the pump accelerates pump slippage. Slippage provides an an additional constraint on a rate at which fluid is produced from a reservoir in that greater slippage decreases a rate of fluid production.

Pump damage may result in lost production if the well is shut down, termed “shut in”, to remove the pump in order to effect repairs or replacement. On the other hand, under-pumping wells to minimize the possibility of pump damage, often leads to decreased production. The pumps last longer, but to protect them producers often leave fluid at the bottom of the well. Too large an amount of liquid causes increased back pressure on the formation, which in turn decreases fluid production.

Well operators may rely on a pump operators' skill to manually control the speed of the pump. In other words, operator knowledge, vigilance, and expertise of the variable flow rates for a well may be required in order to determine setpoints for operation of the pump. Reliance purely on the subjective judgement of an operator may not alleviate over pumping and may not always generate optimum production flow. While, empirical modelling of the formation may aid in predicting production and thus an aid to pump operators, the such modelling does not consider the effect of the lift mechanism.

Determination of the operating point of the pump may be challenging given the many unpredictable factors as discussed above. If a pump is operated at a given speed and a decrease in flow is detected, then a determination may be made as to: 1) whether the pump is operating at too low a speed in other words, where the well may be capable of producing more flow but the current pump speed is not providing sufficient lift, or 2) whether the pump is operating at a speed higher than the well can produce, in other words a pump off condition may be imminent. Based on the option chosen, the operator will either increase or decrease the speed of the pump. Conversely, if an increase in flow is detected while the pump is operated at a given speed, a determination may be made as to 3) whether the pump speed is close to its maximum speed in which case the pump speed may be reduced or held constant to prevent pump-off, or 4) whether the pump speed may be increased, in other words the well is capable of yielding more production by increasing the pump speed. The operator may thus either increase the speed, maintain the speed constant or decrease the speed.

From the scenarios described above it may be seen that the determination as to increase the speed, maintain the speed or decrease the speed of the pump is based on a knowledge of the operator. As mentioned earlier, simply modelling the formation to predict flow and thus anticipate the setpoint (level of flow) may not be effective. Not only is modelling complex but has rarely been able to accurately predict level of flow in variable multi-phase fluids. As may be further appreciated, in a field of multiple wells, control of the pump becomes even more challenging due to the unpredictable influence of neighboring wells in the field.

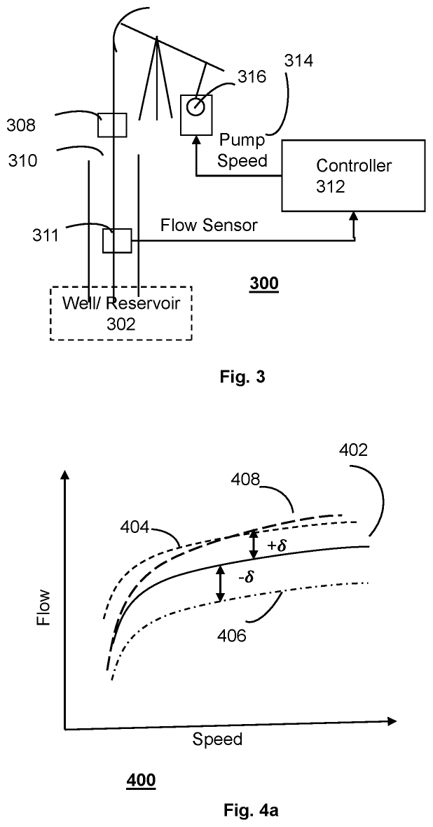

Referring to FIG. 3 there is shown schematically a typical crude oil and/or natural gas production system 300. In general, the system 300 comprises a well 302 having a borehole 310 in an underground formation, a casing in the borehole 310 carries tubing extending from the surface to an underground reservoir. The system 300 further includes a pump to provide mechanical lift of the fluid from the reservoir, the pump may be of different types know in the field. Recall from above that the term pump as used herein encompasses any lift mechanism appropriate to the type of extraction being conducted and the term speed refers to any parameter that may be used to control the pump. In the present example, the pump, such as an above ground pumpjack driving a reciprocating piston in the borehole may be used, however, different pump types known in the art may be used, such as, diaphragm, progressive cavity, gas lift, and such like. The well further includes measuring and recording equipment to produce well data, typically located at the well head 308. The measuring equipment may include a flow meter or meters, or flow sensor or sensors 311. The measuring equipment may or may not be in the fluid path 310 of the extracted fluid. For example, flow may be inferred by measuring collected fluid, such as a level of a storage tank. The system may further include a pump controller 312 that outputs a speed control signal 314 to the pump drive 316 in response to measured, or inferred, fluid flow from the sensor 311. The pump controller 312 may execute an algorithm for increasing pump speed in order to maximize production from the well. The controller 312 may output the speed control signal, typically a preset current, to increase pump speed until a decrease in flow is detected by the flow sensor 311 and/or measuring equipment 306. If a decrease in flow is detected, the pump speed may then be decreased and operated at a lower speed for a period. The speed is then increased again to detect whether flow increases. If the flow increases, the pump speed is again increased until flow decreases or remains constant. The sequence may then be repeated.

While the approach may automate pump control there is still a possibility of operating the pump outside its so-called “nameplate” rating. By way of background, the “nameplate curve” of a pump typically gives the manufacturer-derived relationship between flow and RPM (revolutions per minute) for the pump over a range of pump speeds. The name plate curve generally provides a theoretical or ideal maximum flow obtainable from the pump at various speeds. Generally, manufacturers produce pump tables or curves with the RPM as a domain parameter against which a combination of values of “Total-Head” (output pressure minus intake pressure); horsepower, and flow are provided. In other words, manufacturers typically make available three types of tables: a) RPM against total-head, and horsepower; b) RPM against total-head, and flow; and c) RPM against horsepower, and flow. Due to manufacturing differences each pump, even for the same size and type of pump, has its own unique characteristics. Therefore, every pump may have its own unique set of tables or curves

For simplicity, the present description will exemplify the embodiments by reference to horsepower (hp i.e. may in some instances be represented by pump speed), and flow. In a practical sense this may be the most common application since, the customer's choice of pump practically constrains the hp parameter. This in turn limits flow. Hence for these reasons tables of flow in terms of RPM are most used in the majority of well operations. It will be understood that the tables of RPM versus other parameters as discussed above could equally well be used.

These curves are usually derived under ideal conditions by the manufacturer, typically using a single phase, homogenous fluid such as water. However, these curves rarely reflect the real word performance of the pump when operating in the field with multiphasic, non-homogenous flow.

The question thus arises of how to determine effective parameters to drive control of the lifting action of the pump in order to best optimize well output, while at the same time protecting the pump. Or stated differently how to incorporate the real world dynamic conditions of the well into control of the pump. Driving the pump in a traditional PID (proportional-integral-derivative) type controller to a fixed flow setpoint is inherently flawed as the well production flow may be continually changing.

There is therefore provided according to an embodiment of the present matter, a system and method for generating a well profile, wherein the well profile factors in the actual field conditions of the pump operating in the well and using the well profile to generate operating limits for a pump. In general, the well profile according to one embodiment is defined by a relationship between pump parameters and well characteristics and provides a unique characterization of the well-pump combination. In one embodiment, the well profile may be represented notionally by a curve showing a relationship of a statistical variation in sampled well head data at specific operating points of the pump as a function of the specific operating points. There is also provided according to a further embodiment of the present matter a system and method for dynamically and continually varying operation of the pump within limits that are dynamically varying, wherein the limits dynamic variability is based on conditions of the well and the pump combination, as embodied in the derived well profile, while maximizing fluid extraction from the well and simultaneously protecting the pump from pump-off conditions. Consequently, according to an aspect of the embodiment there is provided a method for optimizing fluid extraction from a well by using the well profile in controlling a pump.

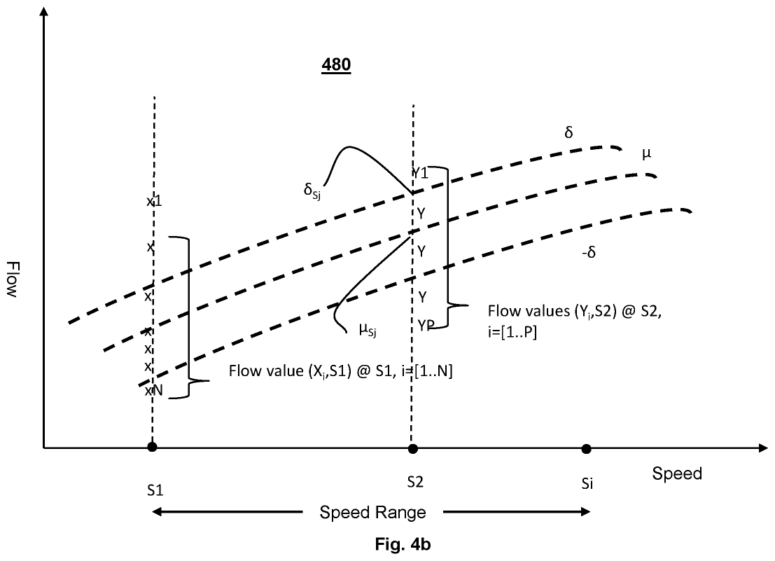

Referring to FIG. 4a there is shown a graphical representation of a well profile 400 according to an embodiment of the present matter. The well profile 400 in one embodiment is a series of computed values derived during well operation which may be graphically exemplified as by a series of curves, as illustrated, a mean curve 402, an upper limit curve 404, and a lower limit curve 406, the limit curves representing a plot of predetermined statistical variations about the mean curve 402 (μ). In an exemplary embodiment this may be a positive standard deviation (SD) (+δ) and/or a negative SD (−δ). In general terms the well profile 400 provides a relationship between the operating points of a pump and the statistical variation values of production at those operating points which may then be used to configure a pump controller. The well profile 400 may for example be used to replace the idealized manufacturer nameplate curve 408.

Referring to FIG. 4b there is shown graphically 480 acquisition of a dataset for deriving the well profile 400 during pump operation. For example, while the pump is operating, at pump speed S1 flow values are sampled at time intervals to derive a dataset of flows X1 . . . Xi . . . XN at speed S1, taken at times (i=1 . . . N). If the pump speed is changed to another speed S₂, then samples of flow values are stored at times (j=1 . . . P) while the pump operates at that speed S₂ to derive a second dataset of flow values Y1 . . . Yi . . . YP at speed S₂. Similarly, this process is repeated during pump operation at different pump speeds in range of pump operational speeds. Of course, the process may also be implemented at a random sampling of flow values at random times and/or random pump speeds during operation, provided that each sampled flow value is correlated with the corresponding pump speed. In deriving the well profile 400, the statistical variation in each of the dataset of flows may be implemented for each of the sets at the different specific pump speeds. In a further exemplary embodiment the dataset of flows may be input from historical data records.

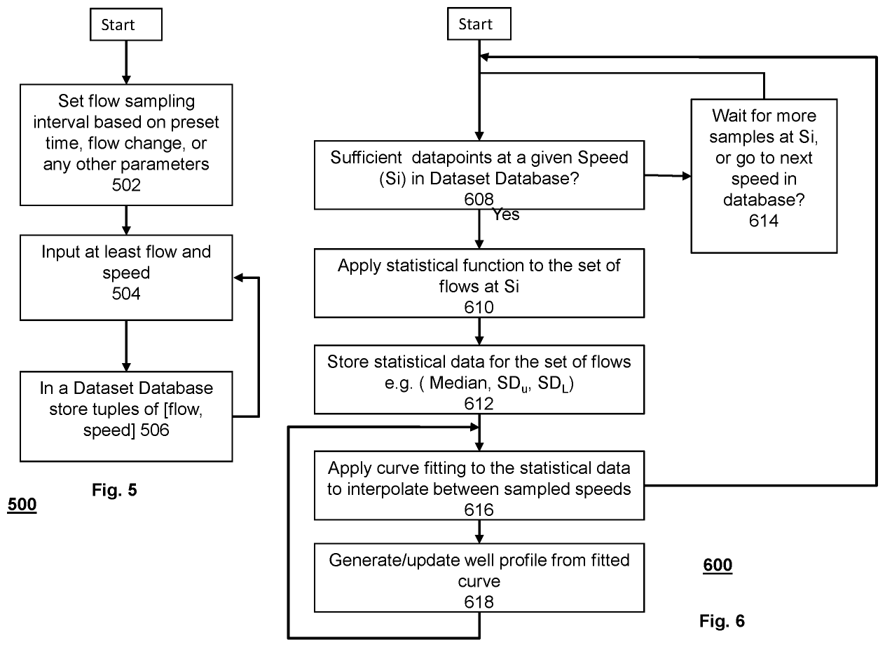

Referring to FIG. 5 there is shown a flow chart 500 for inputting a dataset of flow/speed datapoints which may be used in generating the well profile. At block 502 flow values sampling interval is set based on a pre-set time, flow change, or any other parameters. At block 504 flow values correlated to speed are input at the set sampling interval. At block 506 the dataset database of the flow/speed pairs is stored. The process may then repeat. In instances where historical data for a well, or set of wells are available, the relevant data values may also be input to the dataset.

Referring to FIG. 6 there is shown a flow chart of a method 600 for quantifying statistical variation in the flow dataset to generate the well profile. The method 600 may be executed in parallel with the dataset acquisition method 500. At a block 608 a determination is made whether sufficient datapoints are available at a given speed Si in the dataset database created in block 506. If enough data points are available, then at block 610 a statistical function is applied to the set of flow datapoints at the speed Si. At block 612 statistical data (e.g. mean, SD upper bound (SDub) and SD lower bound (SD_{lb}.)) computed for the set of flow datapoints are stored. At block 616 the statistical data points may be fitted to a curve such that statistical values of flow at the discrete speed points may be interpolated to provide a continuous curve of flow values over the operational speed range of the pump, as for example represented by curves 402, 404, 406 in FIG. 4a. The well profile 400 may then be generated 618 from or represented by these fitted curves. As will be appreciated, when the well profile is applied to control of a pump, this provides a finer grained control as the well profile provides a relationship for the pump and flow in the actual formation. The process 600 may continue as additional data points are added to the dataset database and the statistical data is recomputed, thus the well profile continues to be dynamically updated to reflect continual changes in the reservoir.

In summary, statistical variation as embodied in the well profile 400 may be quantified, by a known statistical measure such as for example one or more standard deviations (SD's or u) of the flow measurements at a given pump speeds. Such variations may be determined at multiple given pump speeds over a range of pump speeds. Operation of the lift mechanism is then effected by actively varying operational parameters of the pump lift mechanism (such as pump speed control signal) within limits of the determined variation in flow as defined in the generated well profile 400.

Accordingly, in one embodiment of the present matter, a system and method for generating a well profile 400 is based on a variance in the flow dataset. The flow may follow a normal distribution (or other statistical distribution function). Calculation may be made of the SD (from the variance) of in-field flow variations determined at corresponding pump operating parameter points such as one or more of speed, duration of pump on- and/or-off time, or a combination thereof. The SD may then be calculated for the set of values at the selected pump operating points and notionally fitted to a curve as a function of the pump operating points. As mentioned earlier, this curve may be plotted as the upper and lower limit curves 404 and 406 alongside the mean curve 402. The operating parameters of the pump may then, for example, be constrained to be within the upper and lower SD curves 404 and 406, respectively. For example, the SD curves may provide an upper bound 404 and lower bound 406 flow values to constrain the range of RPMs over which the pump may be operated outside the name plate curve 408.

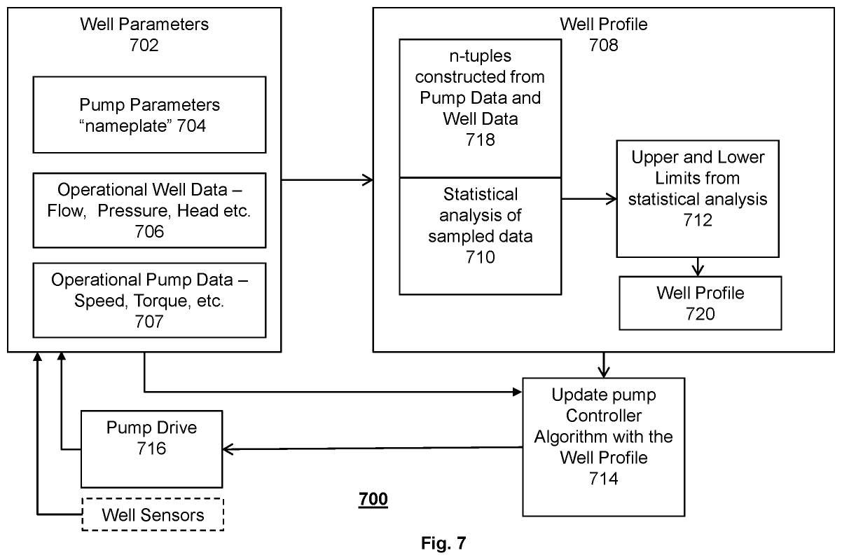

Referring to FIG. 7 there is shown a schematic flow diagram 700 for implementing a method to optimize fluid production by a pump in a well using a well profile 400 according to an embodiment of the present matter. The method 700 comprises inputting well parameters 702 including pump parameters 704, pump operational data 707 and well data 706 into a processor; generating from the input well parameters the well profile 708 defined by variations in sampled input well data-at a selected value of the input pump operational data over a range of values of the pump operational data; and applying the generated well profile in a pump control algorithm 714 to set operation limits of the pump 716, such that flow is optimised. The process 700 may further include updating the well profile with ongoing samples of the well data and updating the control algorithm with the updated well profile. As may be seen the pump parameters 704 may be the “nameplate” parameters for the pump. In some instances, the well profile may be comprised of the nameplate parameters, particularly at the initial operating stage of the well when insufficient well head data is available to derive operational information. In other words, the initial dataset may be the pump curve determined in the factory. This will guarantee there will always be at least 2 data points to determine next steps on, the current flow and the factory determined ‘best’ flow for a speed.

Operating the pump using this initial well profile at the nameplate parameters optionally provides a baseline, or reference for the subsequent in-field measurements. Well data 706 may, in one embodiment, be obtained while the pump is being operated from for example one or more flow sensors and other well measurement instruments, such as pressure etc. Pump operational data 707, may include any one or more of sampled pump speed, torque, on-off time etc. corresponding to the sampled well head data. In mathematical terms the sampled well head data and corresponding pump operational data 718 may be considered an n-tuple, with n being typically 2.

As described earlier standard deviation (δ) may be used as one example statistical distribution to quantify the statistical variability of a data sample sampling in the operation of the pump. This may be performed by for example, initially assuming a mean (μ) value, to be the flow value taken from the manufacturer nameplate curve 408 at a desired operating point, for example Sᵢ, in the range of RPMs. Then, while operating the pump in field, sample flows, f at the specific desired operating point RPM, Sᵢ, of the pump, and calculate the squared difference (fᵢ−μ_{Si})² Repeating the sampling of the flow at the RPM Sᵢ, gives the population of the in-field flow values at that RPM. The standard deviation σ_{Si}, of the sampled flows at Sᵢ may be calculated for example from the following relationship, where N is the number of samples at the specific operating point, Sᵢ, of the pump (of course SD is simply a square root of the variance):

$${σ}_{{S}_{i}} = \sqrt{\frac{1}{N} {\sum }_{j = 1}^{N} {( {f}_{j} - {μ}_{{S}_{i}} )}^{2}} \qquad ( 1 )$$

This process may then be repeated over a range of RPMs, Sᵢ(i=1 . . . M). The SDs and RPMs may be expressed as tuples over the range of RPMs. For example [σi, Sᵢ], (i=1 . . . M). The set of tuples may be used to generate an upper bound and lower bound curve of flow versus RPM, as for example shown previously in FIG. 4a. In the instance where the nameplate curve is used as the mean μ in generating the SD, the upper bound and lower bound curves may lie on either side of the name plate curve as shown in FIG. 4a. In other instances, a mean may be derived from the input sampled flow data. In this instance the derived mean may replace the nameplate curve 408 and the upper bound 404 and lower bound 406 may also lie on either side of the derived mean curve. The statistical distribution function of the data point may or may not be a normal distribution. The variability curves described herein may be implemented on any distribution of point including one or more of a well-known Frequentist inference method, or Bayesian inference method or any other probability distribution scheme.

Once the upper bound and lower bound are determined, the pump controller maybe configured to execute an algorithm for increasing or decreasing pump speed in order to maximize production from the well controller within the dynamically varying the operating limits of the lift mechanism configured with the SD upper bound SD_{ub} and the SD lower bound SD_{lb}. The controller may be further configured to provide that the SD bounds may be user selectable. In other words, the bounds may or may-not be the same value (asymmetric) around the mean at each RPM, and/or may be selected to be any multiple of SDs or even a fraction thereof. For example, SD_{ub}=SD_{lb}, when SD is selected as symmetric and SD_{ub}≠SD_{lb} when selected as asymmetric. It is preferable for optimal pump protection that the SD may be smaller for the lower bound value, than for the upper bound value. So by default, SD_{ub}≥SD_{lb} (or conversely SD_{lb}≤SD_{ub}). Hence the comparative values for the flow SD may by default be asymmetric with for example two times the SD from (2xSD) the mean as illustrated by the curve, for the SD_{ub}. In turn the SD_{lb} may be defined as, 0.5xSD or a single SD (1xSD) or 1.5 times the SD (1.5xSD) from the mean. As described earlier, the mean curve 402 may in one embodiment be the nameplate mean or in another embodiment be a new mean that is empirically derived in the field.

The controller may be further configured to provide that if the curve of the measured flow falls a user selectable number of SDs (either above or below) the manufacturer's nameplate pump curve, then the controller may drive the pump to bring the measured or derived curve closer to the nameplate pump curve.

As may be seen in the well profile used to characterize a crude oil and/or natural gas production system, the data plotted of flow rate versus pump speed can be analyzed with calculated SDs. A low SD means that most of the flow rate values are very close to the mean; a high SD means that the flow rate values are more spread out. One possible interpretation is as follows. A low SD implies that the flow rate is more sensitive to pump speed compared to a high SD case where the flow rate is less sensitive to pump speed. In other words, if the profiles (flow vs pump speed) of two wells are compared, the profile with the lower SD could be viewed to demonstrate a system which is more sensitive to control. Furthermore, if a band from −1σ to +1σ is used to control a system, one with a lower SD can be viewed as being more sensitive to change. In other words, a profile of a well with a low SD characterizes a system which is more predictable in its operation compared to one with a high SD.

In one embodiment according to the present matter, the well profile may be applied in a controller configured with the following parameters:

S(1)—Min. Speed

S(n)—Max. Speed

S(c)—Current Speed

S(c−1)—Next Lower Speed

F(c)—Current Flow at Sc

F(c−1)—Previous Flow at S(c−1)

F(c)—Current Flow at Sc

μF(c)—Mean (Average) of Flows at Speed c

σF(c)—Standard Deviation of Flows at Speed c

% σF(c)—Some positive percentage of σF(c)

(1) Is F(c) ≥ F(c−1) + σF(c−1) ?
IF Yes -

Is S(c) < S(n) ? Then, Increase Speed to S(c+1).
Goto (1)

IF No - Goto (2)
(2) Is F(c) < F(c−1) + %σF(c−1)?
IF No - Maintain Speed at speed S. Goto (1)
IF Yes -

Is F(c) < F(1) ? Then, Stop the Pump, Wait for
either automatic or manual re-
start.
Otherwise, Is F(c) ≥ F(1) ? Then find min.
speed S(x) < S(c) such that F(x) >
F(c), and set the new Speed to S(x). S(x) is the
min. speed necessary to capture
the current flow.
Goto (1)

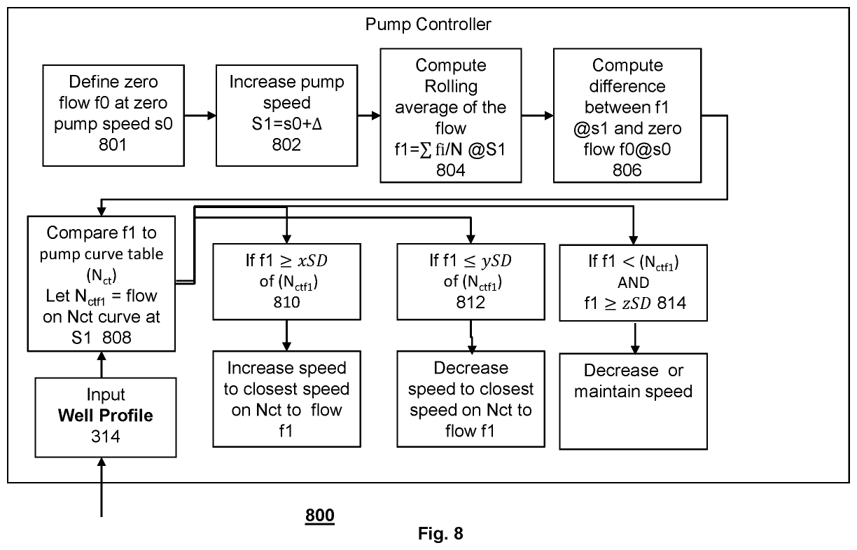

Referring to FIG. 8, there is shown a generalized flowchart 800 of a method for controlling the pump using a generated well profile 402, 404, 406 according to an embodiment of the present matter. At block 801 define zero flow (f₀) and zero speed (s₀). Note in some instances the actual speed of the pump may be nonzero at the so called zero flow. At block 802 increase the pump speed by a known amount to a new speed (s₁). At block 804 compute a rolling average of the flow (f₁) at the new speed at (s₁). At block 806 take a difference between the flow (f₁) at (s₁) and the flow (f₀) at (s₀). At block 808 compare the value of the difference in flows, to the value given by the nameplate pump curve table (N_{ct}). The curve used for comparison may also be empirically derived. Label this initial name plate flow at (s₁), as (N_{ctf1}). At block 810 if (f₁)≥xSD of (N_{ctf1}), increase the pump speed to the speed closest to that given by the (N_{ct}) for the measured flow. For example, this accommodates large flow increases. At block 812 if (f₁)≤ySD of (N_{ctf1}), increase the pump speed to the next speed given by the (N_{ct})—for the measured flow. At block 814 if (f₁) is <(N_{ctf1}) OR ≥z SD of (N_{ctf1}), decrease or maintain speed. However, simultaneously with or subsequent to the building of the pump curve as described above, the flow is monitored and if the monitored flow changes, then build a table of the ordered pairs of flow against speed [fᵢ,sᵢ] with (f₀) at the defined zero speed (s₀), (f₁) at the speed at (s₁) and so on. Hence tables of ordered pairs [f₀, s₀], [f₁, s₁] . . . [fₙ, sₙ] are constructed. We now have a field derived series of ordered pairs [fᵢ,sᵢ] at each of the pump speeds sᵢ.

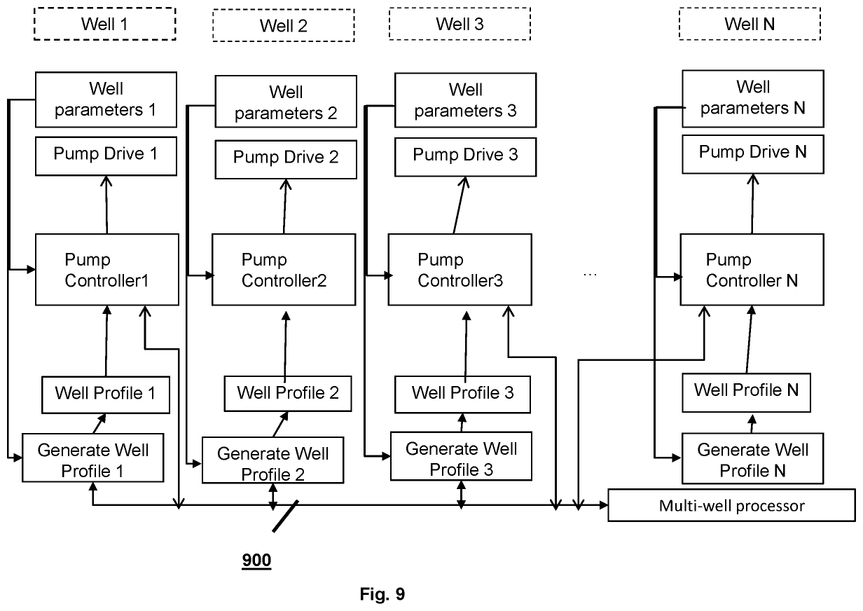

Referring now to FIG. 9, there is shown a controller 900 for a field of pumps according to an embodiment of the present matter. A field may be defined as a group of two or more pumps operating in wells in some geographic proximity in a geological formation in which there may be some interrelationship in flows between the wells. The idea is to treat a group of contiguous wells as a matrix, Contiguous means geologically related and also related by drilling and completion methods. Recall that for each individual wellᵢ well, there may be a set of ordered pairs of [fi,si]_{w} i=0 . . . n having elements (f₀, s₀) . . . (fₙ, sₙ) of flow versus speed which may be computed as described earlier. Thus a field of N wells will have N sets of ordered pairs [fᵢ,sᵢ]_{w}, w=1 to N. As previously described for the single well, when the speed of the pump changes, build a table of the ordered pairs (f₀) at zero speed (s₀), (f₁) at the speed at (s₁) and so on. Hence a table of ordered pairs (f₀, s₀), (f₁, sₙ) for each well in the field is created.

As in the foregoing standard deviation method used to control a single well, each subset can now be optimized individually. For example, consider a three (3) well scenario (it is also assumed that production engineers know they are related. In other words, it is assumed that that the production engineers know they are not singletons). Choose one (1) well (may be arbitrary); call this well, well B. Apply the pump speed control as described above. Hold the other two well pump speeds constant. In other words, constant speed. Call these other two wells A and C; monitor production from all three. If production from A declines, implement the pump control algorithm as described earlier on A. Continue to monitor production, and if production from C declines, implement the algorithm on C. Continue to monitor production. If production from both A and C decline, implement algorithm on both A and C. Continue to monitor production. Continue to repeat the process from the beginning as described above.

It may now be seen that the triplet as described above may be treated as a single well. In other words, the triplet would be treated as a singleton for extending the optimization to a a numbers of wells in the field.

In a further embodiment, the present system and method may be extended to multiple wells in a field. In this embodiment, a notional grid may be overlaid on the global oil field to establish a matrix of rows/columns each cell representing a well in the field with its specific address. In other words, each well represents an element in the global matrix. This element is used to store all relevant data associated with the well, such as pump speed, hydrocarbon output, transfer function and standard deviations.

A cluster of wells is selected, for example a triplet as described above, and the production optimized. This cluster can be viewed as a sub-matrix in the global matrix. After optimization, the cluster is considered to be a singleton, another cluster is chosen, and the optimization process continues.

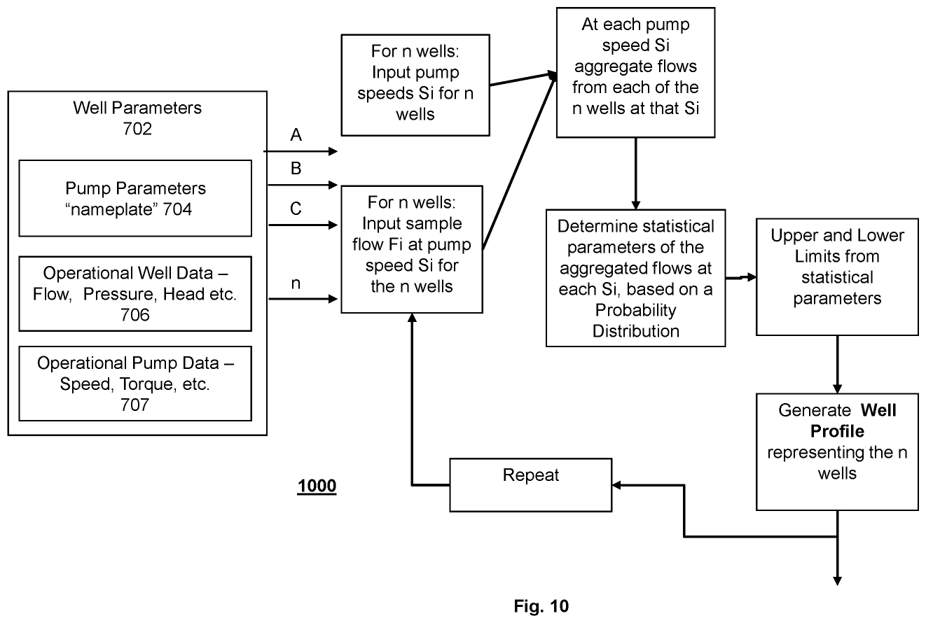

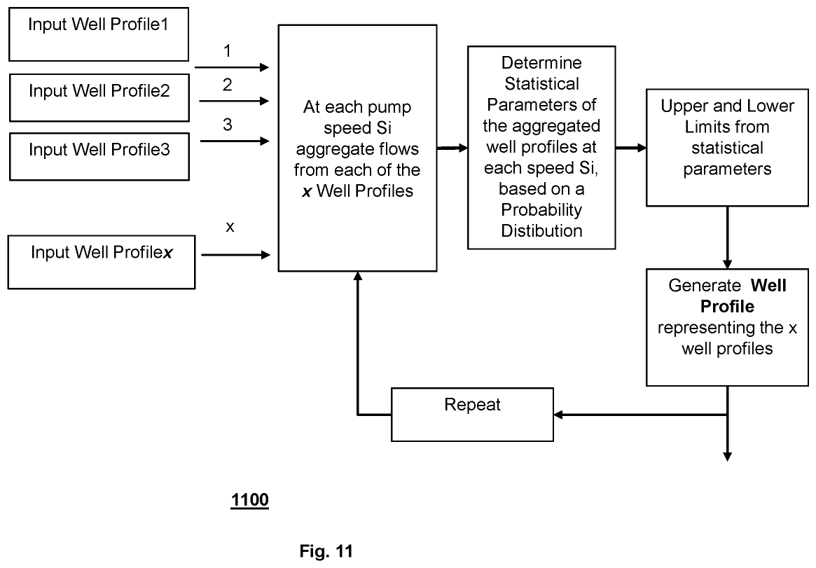

Referring to FIG. 10, there is shown a flow chart 1000 for generating a well profile for a group of wells in a field according to an embodiment of the present matter. In this embodiment the statistical distribution analysis is applied to input flows (aggregated) from two or more wells at a given pump speed in common. These aggregated data points of flow may be treated as single flow values (representing aggregated flow from the multiple wells) at a given speed. A well profile may then be generated using the values aggregated flow versus speed in the single well instance described above.

Referring to FIG. 11 there is shown a further flow chart for generating a well profile for a group of wells in a field according to an embodiment of the present matter. Similar to the method shown by the flow chart of FIG. 7, well profiles for single or groups of wells may be input and be combined to generate a new well profile representing the aggregate of the input wells represented by the input well profiles. It may also be seen in a further embodiment that any well profile may also be combined with well data from one or more wells to generate a new well profile in order to represent the input constituent wells.

In summary the present system and method optimizes well production by generating a well profile that models in operation both the pump characteristics and the well characteristics and using the profile to dynamically control the pump for optimal production while protecting the pump. It may be seen the well profile takes into account the effect of the particular pump on the fluid production, thus providing a more realistic and dynamic pump curve.

1. A method for characterizing a well, comprising:
inputting well data, to a processor; and
generating from the input well data a well profile, the well profile having a plurality of statistically derived values, each said statistical value corresponding to respective operating points of the pump, and each of the plurality of statistically derived values being derived from respective statistical analyses taken at the respective operating points of the pump, each of the plurality of statistical values being based on a respective analysis of a plurality of sampled well data at a common operating point.

2. The method of claim 1, the well data including manufacturer pump parameters, pump operational data.

3. The method of claim 1 including applying the generated well profile to a pump control algorithm.

4. A pump controller comprising:
a memory; and
a processor configured to:
input well data;
generate from the input well data a well profile, the well profile having a plurality of statistically derived values, each said statistical value corresponding to respective operating points of the pump operational data, and each of the plurality of statistical values being derived from respective statistical analyses taken at the respective operating points, each of the plurality of statistical values being based on a respective analysis of a plurality of sampled well data at a common operating point.

5. A method for optimizing production from a well, the method comprising:
inputting to a processor well parameters, the well parameters including pump operational data, and well data, the pump operational data including at least one operating point of a pump;
obtaining, at respective ones of the operating points of the pump, a plurality of samples of the well data;
deriving a representation of variation in a set of the samples at a selected one of the operating points of the pump; and
generating a well profile, the well profile representing a relationship between the selected operating points of the pump and the variance representations at those operating points.

6. The method of claim 5, including applying the generated well profile to a pump controller for the control of the operating point of the pump.

7. The method of claim 5, wherein the representation of variation is a variance.

8. The method of claim 5, wherein the well profile includes standard deviations based on the variance.

9. The method of claim 5, wherein the well profile includes standard deviations and means, both based on the variance.

10. The method of claim 5, wherein the well data includes at least fluid production information.

11. The method of claim 5, well parameters further include manufacturer pump parameters.

12. The method of claim 5, including updating the well profile with ongoing samples of the well data and updating a pump control algorithm with the updated well profile.

13. The method of claim 5, including using one or more of a Frequentist inferences, and Bayesian inference for deriving the variations in sampled data.

14. The method of claim 5, including generating well profiles for respective ones of a plurality of wells.
